(19) United States
(12) Patent Application Publication
(10) Pub. No.: US 2021/0136996 A1
(43) Pub. Date: May 13, 2021

(54) SYSTEMS AND METHODS FOR APPLYING AN AGRICULTURAL PRACTICE TO A TARGET AGRICULTURAL FIELD

(71) Applicant: Supplant Ltd., Afula (IL)

(72) Inventors: Zohar BEN-NER, Kfar Yehoshua (IL); Leonid SLAVKIN, Haifa (IL); Adolfo Gabriel LEVIN, Kibbutz Lahavot HaBashan (IL); Agustin PIMSTEIN, Tel-Aviv (IL); Igor ZACHS, Petach Tikva (IL); Liyam SHEMESH, Kibbutz Dalia (IL)

(73) Assignee: Supplant Ltd., Afula (IL)

(21) Appl. No.: 17/052,252

(22) PCT Filed: May 2, 2019
(86) PCT No.: PCT/IL2019/050491

§ 371 Date: Nov. 2, 2020

Related U.S. Application Data
(60) Provisional application No. 62/665,654, filed on May 2, 2018.

(51) Int. Cl. A01B 79/00; G06K 9/00; G06K 9/62; G06F 16/9035

(52) U.S. Cl. CPC A01B 79/005; G06F 16/9035; G06K 9/6267; G06K 9/00657

(57) ABSTRACT

There is provided a method comprising: computing state parameter(s) indicative of a state of a target crop at the target field based on output of crop physiological sensor(s), and classifying by a classifier(s), the state parameter(s) and the agricultural practice(s) into instructions for administration of the agricultural practice(s) to the target field, wherein yield and/or quality of the target crop at a future target event is predicted to be increased when the instructions are implemented relative to the yield and/or quality of the target crop that is predicted at the future target event when an alternative administration of the agricultural practice(s) is implemented, wherein the classifier(s) computes the instructions based on previously obtained instructions associated with respective reference fields associated with respective state parameter(s), and yield and/or quality of respective reference crops at respective reference fields at historical reference events corresponding to the future target event.

### RELATED APPLICATION SECTION

This application claims the benefit of priority of U.S. Provisional Patent Application No. 62/665,654 filed on May 2, 2018, the contents of which are incorporated herein by reference in their entirety.

### BACKGROUND

The present invention, in some embodiments thereof, relates to agricultural practices and, more specifically, but not exclusively, to systems and methods for administration of an agricultural practice to a field of crops.

In modern agriculture, many agriculture practices take place along the growing season. Timing of the administration of the agricultural practice affects the final crop yield in terms of quantity and quality.

### SUMMARY

According to a first aspect, a computer implemented method of providing a client terminal with instructions for administration of at least one agricultural practice to a target field, comprises: obtaining a selection of at least one agricultural practice for administration to the target field, computing based on output of at least one crop physiological sensor monitoring a target crop of the target field, at least one state parameter indicative of a state of a target crop at the target field, inputting into at least one classifier, the at least one state parameter of the target field and the at least one agricultural practice, classifying by the at least one classifier, the at least one state parameter and the at least one agricultural practice into instructions for administration of the at least one agricultural practice to the target field, wherein at least one of yield and quality of the target crop at a future target event is predicted to be increased when the instructions for administration of the at least one agricultural practice to the target field are implemented relative to the at least one of yield and quality of the target crop that is predicted at the future target event when an alternative administration of the at least one agricultural practice is implemented, wherein the at least one classifier computes instructions for administration of the at least one agricultural practice based on previously obtained instructions for administration of agricultural practices to respective reference fields associated with respective at least one state parameter, and at least one of yield and quality of respective reference crops at respective reference fields at historical reference events corresponding to the future target event, and providing the instructions for administration of the at least one agricultural practice to the target field to the client terminal.

According to a second aspect, a system for providing a client terminal with instructions for administration of at least one agricultural practice to a target field, comprises: a non-transitory memory having stored thereon a code for execution by at least one hardware processor, the code comprising: code for obtaining a selection of at least one agricultural practice for administration to the target field, code for computing based on output of at least one crop physiological sensor monitoring a target crop of the target field, at least one state parameter indicative of a state of a target crop at the target field, code for inputting into at least one classifier, the at least one state parameter of the target field and the at least one agricultural practice, code for classifying by the at least one classifier, the at least one state parameter and the at least one agricultural practice into instructions for administration of the at least one agricultural practice to the target field, wherein at least one of yield and quality of the target crop at a future target event is predicted to be increased when the instructions for administration of the at least one agricultural practice to the target field are implemented relative to the at least one of yield and quality of the target crop that is predicted at the future target event when an alternative administration of the at least one agricultural practice is implemented, wherein the at least one classifier computes instructions for administration of the at least one agricultural practice based on previously obtained instructions for administration of agricultural practices to respective reference fields associated with respective at least one state parameter, and at least one of yield and quality of respective reference crops at respective reference fields at historical reference events corresponding to the future target event, and code for providing the instructions for administration of the at least one agricultural practice to the target field to the client terminal.

According to a third aspect, a computer implemented method of training at least one classifier for classifying at least one agricultural practice and at least one state parameter of a target field into instructions for administration the at least one agricultural practice to the target field, comprises: providing a training dataset, including a plurality of records for a plurality of reference fields, each record of each respective reference field storing: instructions of at least one agricultural practice administered to the respective reference field, at least one stress parameter indicative of a state of a reference crop at the respective reference field computed based on output of at least one crop physiological sensor monitoring the reference crop, and at least one of yield and quality of the target crop at a historical reference event, and training at least one classifier according to the training dataset for classifying at least one agricultural practice and at least one state parameter of a target field into instructions for administering the at least one agricultural practice to the target field, wherein at least one of yield and quality of the target crop at a future target event is predicted to be increased when the instructions for administration of the at least one agricultural practice to the target field are implemented relative to the at least one of yield and quality of the target crop that is predicted at the future target event when an alternative administration of the at least one agricultural practice is implemented.

In a further implementation form of the first, second, and third aspects, the at least one state parameter includes at least one of: at least one stress parameter indicative of stress experienced by the target crop, at least one growth parameters indicative of growth of the target crop, and at least one physiological parameters indicative of a physiological condition of the crop.

In a further implementation form of the first, second, and third aspects, the instructions for administration comprises a certain time for administration of the at least one agricultural practice to the target crop.

In a further implementation form of the first, second, and third aspects, the certain time is selected from the group consisting of: a certain phenological stage of the target crop, degree days, and a calendar date.

In a further implementation form of the first, second, and third aspects, the instructions for administration comprise machine readable instruction provided to an agricultural controller for automatic implementation of the at least one agricultural practice.

In a further implementation form of the first, second, and third aspects, the instructions for administration are presented on a display of the client terminal as human readable instructions for manual implementation by a user.

In a further implementation form of the first, second, third, and fourth aspects, the method and/or the system further comprise providing a target field profile of the target field including a plurality of parameters remaining substantially static over the growing season of the target crop growing in the target field, and wherein the classifier performs the classification according to reference field profiles of respective reference fields correlated to the target field profile according to a correlation requirement.

In a further implementation form of the first, second, third, and fourth aspects, the method and/or the system further comprise selecting a subset of reference fields that correlate to the target field according to the correlation of the target field profile of the target field and the reference field profiles of the reference fields, and dynamically training the at least one classifier according to the subset of reference fields.

In a further implementation form of the first, second, third, and fourth aspects, the method and/or the system further comprise monitoring administration of the at least one agricultural practice according to the instructions by iterating the inputting into the at least one classifier, and the classifying, for a plurality of state parameters associated with different sequential time intervals obtained at least one of: during administration of the at least one agricultural practice according to the instructions classified by the at least one classifier and after administration of the at least one agricultural practice according to the instructions classified by the at least one classifier, wherein the classifying the plurality of state parameters dynamically adjusts the instructions for administration of the at least one agricultural practice.

In a further implementation form of the first, second, and third aspects, the at least one state parameter is further associated with a timestamp including one or more members selected from the group consisting of: calendar day and time, phenological stage of the target crop, and degree day within a growing season, wherein the classifier further performs the classification according to the timestamp.

In a further implementation form of the first, second, and third aspects, the at least one state parameter is automatically selected from a plurality of state parameters according to the selected at least one agricultural practice.

In a further implementation form of the first, second, and third aspects, the at least one classifier searches records of a dataset by matching the at least one state parameter of the target field to at least one state parameter of at least one reference field, wherein the dataset stores records each including: indications of at least one state parameter of respective reference fields, indications of agricultural practices administered to respective reference fields, and at least one of yield and quality of respective reference crops of the respective reference fields at historical reference events, wherein the instructions for administration of the at least one agricultural practice to the target field are obtained according to the indication of agricultural practices administered to the reference field of at least one matched record.

In a further implementation form of the first, second, and third aspects, the at least one state parameter includes a normalized value within a range of maximum possible state and minimal possible state.

In a further implementation form of the first, second, and third aspects, the at least one state parameter is selected from the group consisting of: nutritional deficit, toxicity level, water deficit, and photosynthesis blockage.

In a further implementation form of the first, second, and third aspects, the at least one state parameter is computed by at least one state classifier trained according to a training dataset of output of crop physiological sensors and associated data indicative of a certain value of the state.

In a further implementation form of the first, second, and third aspects, the at least one state parameter comprises a plurality of state parameters each associated with a respective sequential timestamp over a time interval, wherein the plurality of state parameters denote dynamic changes for the target field over the time interval.

In a further implementation form of the first, second, and third aspects, the instructions include instructions for administration of another at least one agricultural practice to the target field, wherein the instructions for administration of another at least one agricultural practice are selected for adjustment of the at least one state parameter(s) of the target field associated with a prediction of at least one of yield and quality of the target crop at the future target event according to the at least one adjusted state parameter(s) relative to the at least one of yield and quality of the target crop at the future target event according to the at least one state parameter(s) without the adjustment.

In a further implementation form of the first, second, and third aspects, the at least one crop physiological sensor is selected from the group consisting of: dendrometer, stem diameter sensor, fruit diameter sensor, leaf diameter sensor, crop growth rate sensor, leaf temperature sensor, soil moisture sensor, environmental temperature sensor, solar radiation sensor, wind sensor, relatively humidity sensor, and airborne or satellite image sensor.

In a further implementation form of the first, second, and third aspects, the at least one agricultural practice is selected by a user via a graphical user interface (GUI) presented on a display of the client terminal, and wherein a human readable version of the instructions for administration are presented within the GUI.

In a further implementation form of the first, second, and third aspects, the at least one state parameter is selected by the user via the GUI from a plurality of state parameters.

In a further implementation form of the first, second, and third aspects, a plurality of potential agricultural practices for administration to the target field are computed based on an analysis of the reference fields, the plurality of potential agricultural practices are presented within the GUI, and the at least one agricultural practice is selected by the user via the GUI from the plurality of potential agricultural practices presented within the GUI.

In a further implementation form of the first, second, and third aspects, the at least one agricultural practice is selected from the group consisting of: irrigation, chemical pesticide, chemical fertilizer, pruning, thinning, harvesting, and bio-stimulant.

In a further implementation form of the first, second, and third aspects, each record of each respective reference fields stores a plurality of at least one state parameter computed at each of a plurality of sequential time intervals spanning an entire growing season of the respective reference crop growing at the respective reference field.

In a further implementation form of the first, second, and third aspects, the training dataset is updated based on an indication of the at least one state parameter for each of the plurality of sequential time intervals transmitted by each of a plurality of reference client terminals associated with each respective reference field to a server storing the training dataset.

In a further implementation form of the first, second, and third aspects, the classifier is trained in real time according to the updated version of the training dataset.

In a further implementation form of the first, second, and third aspects, each record of each respective field stores a reference field profile including a plurality of parameters remaining substantially static over the growing season of the reference crop growing in the reference field, and wherein the at least one classifier is trained according to the reference field profiles.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of computing instructions for applying one or more agricultural practices to a target field based on output of one or more crop physiological sensor(s) and computed by one or more classifiers based on previously obtained instructions for administration of agricultural practices to respective reference fields, in accordance with some embodiments of the present invention;

FIG. 2 is a block diagram of components of a system for computing instructions for applying one or more agricultural practices to a target field by one or more classifiers and/or for training the one or more classifiers, in accordance with some embodiments of the present invention;

FIG. 3 is a dataflow diagram depicting dataflow for creation of a reference dataset, in accordance with some embodiments of the present invention;

FIG. 4 includes graphs depicting the fluctuation of crop water stress index (CWSI) in winter wheat under three different irrigation regimes and under three different approaches for computing the index, useful for helping to understand some embodiments of the present invention;

FIG. 5 is a schematic depicting dataflow from a target field to a crop dataset, and back to target field, in accordance with some embodiments of the present invention;

FIG. 6 is a graph depicting seasonal stem diameter measurements performed as part of an experiment, in accordance with some embodiments of the present invention; and

FIG. 7 is a graph depicting dates of application of the bio-stimulant according to growth curves of the corn during the 2016 and 2017 experiment seasons respectively, in accordance with some embodiments of the present invention.

### DETAILED DESCRIPTION

The present invention, in some embodiments thereof, relates to the application of agricultural practices and, more specifically, but not exclusively, to systems and methods for computation of instructions for administration of an agricultural practice to a field of crops.

As used herein, the term agricultural practice refers to, for example, one or more of the following: chemicals applications, fertilization, irrigation, agrochemical product, bio-stimulant, and pruning techniques. The agricultural practice represents an activity and/or event that is applied to the field based on an expectation that the agricultural practice will improve the yield and/or quality of the crops at a future event (e.g., harvest) in comparison to the yield and/or quality of the crops that would otherwise be obtained when the agricultural practice is not applied. Is it noted that the agricultural practices may represent activities and/or events that have been routinely applied based on years of experience in growing crops, in which case, at least some of the systems, methods, and/or code instructions described herein improve the technology of application of the agricultural practices by fine tuning the instructions for application of the agricultural practices (as described herein) based on data collected from other similar reference fields where similar agricultural practices are applied. Alternatively, the agricultural practices may represent activities and/or events which are fairly new, for example, new technologies. In such cases, at least some of the systems, methods, and/or code instructions described herein improve the instructions for application of the new technology based on data collected from other similar reference fields where the new agricultural practice technology is being tested and/or used with little experience. Alternatively, the agricultural practices may represent activities and/or events that are based on objective decisions, for example, pest control is based on the amount of individual pests captured in traps. In such cases, at least some of the systems, methods, and/or code instructions described herein improve the technology of application of the agricultural practices by fine tuning the instructions for application of the agricultural practices (as described herein) according to objective measures based on data collected from other similar reference fields where similar agricultural practices are applied according to the objective measures.

As used herein, the term field and/or crop refers to, for example, open field vegetables, field crops, orchards, and/or green houses.

As used herein, the terms reference crops and/or target crops refer to edible plants and/or non-edible plants used for other purposes, for example, mango, medical marijuana, cotton, wheat, apples, and rosemary.

As used herein, the terms applying and administering, where referring to the agricultural practice, are interchangeable.

An aspect of some embodiments of the present invention relates to systems, methods, and/or code instructions (i.e., stored in a data storage device and executable by one or more hardware processors) for providing a client terminal with instructions for applying one or more agricultural practices to a target field, optionally, the interval of time for applying the agricultural practice(s), for example, in terms of phenological stage, degree days, and/or calendar date. One or more agricultural practices are selected for administration to the target field. One or more crop state parameters indicative of a state of a target crop growing in the target field are computed based on output of one or more crop physiological sensors that monitor the target crop. The crop state parameters may include, for example raw data outputted by the sensor(s), aggregation of data outputted by sensor(s) (e.g., computation of an average value of the data outputted by the sensor(s) over a time interval), and/or computation of one or more values according to the data outputted by the sensor(s) (e.g., computed according to a function, equation, and/or machine learning algorithm). The crop state parameter(s) may include, for example, one or more stress parameters indicative of stress experienced by the target crop, one or more growth parameters indicative of growth of the crop, and/or one or more physiological parameters indicative of a physiological condition of the crop. One or more classifiers classify the state parameter(s) and the agricultural practice(s) into instructions for administration of the agricultural practice(s) to the target field. The yield and/or quality of the target crop at a future target event (e.g., end of growing season) is predicted to be increased when the instructions for administration of the agricultural practice(s) to the target field are implemented, in comparison to when the agricultural practice(s) are administered using an alternative approach, for example, applied during a different time interval. The instructions for administration of the agricultural practice(s) may be in a machine-readable code for automatic implementation by an agricultural controller and/or may be presented on a display in human readable form for manual implementation by a user.

Optionally, the classifier performs the classification by searching a dataset of records of reference fields by matching the state parameter(s) of the target field to state parameter(s) of the reference fields. Each record of the dataset stores: (i) an indication of state parameter(s) of a respective reference field computed based on output of reference crop physiological sensors located at the respective reference field, (ii) an indication of agricultural practice(s) administered to the respective reference field, and (iii) yield and/or quality of the respective reference crop at the respective reference field at a historical reference event(s). The matching may be further performed according to a correlation between a field profile of the target field and field profiles of the reference fields. The instructions for administration of the agricultural practice(s) to the target field are obtained by identifying the matched records associated with highest yield and/or quality, and extracting the instructions that were used to apply the agricultural practices to the target fields that results in the highest yield and/or quality at a historical time event.

At least some of the systems and/or methods and/or code instructions described herein relate to an improved process to the technological field of administration of agricultural practices to growing crops and/or defining when to apply certain agricultural practices. At least some of the systems and/or methods and/or code instructions described improve crop yield and/or quantity at a target event (e.g., harvest) in comparison to other processes of applying agricultural practices to crops, such as manual selection based on common practice and/or common guidelines. The improvement is at least based on crop physiological sensors that monitor crops at multiple time intervals (e.g., continuously, and/or spaced apart by a certain time span), for example, in comparison to manual methods that are based on discrete samples (e.g., one time values). The crop physiological sensors provide output at a selected resolution at multiple points over a time interval, in comparison to point-based sensing of other methods that rely on samples which are widely spaced apart in time. Computation of the crop state parameter(s) at multiple instances over the time intervals provides a dynamic and/or real time indication of the current state of the crop, for example, response of the reference crop to stress, growth of the crop, and/or the current physiological state of the crop.

At least some of the systems and/or methods and/or code instructions described herein provide an improvement to the technology of administration of agricultural practices to growing crops based on dynamic adjustment of the administration of the agricultural practices according to the current state of the crop, based on the state parameter(s) computed from crop physiological sensor(s) monitoring the crop and/or field. For example, the reaction and/or changing speed of the state parameter as a consequence of change in soil water content and/or in the presence of other stressor(s) may be quickly identified. Small effects of the stressing agent on the reference crop may be identified. The instructions for administration of agricultural practices may be adjusted accordingly.

At least some of the systems and/or methods and/or code instructions described herein provide an improvement to the technology of administration of agricultural practices to growing crops based on a large amount of data collected from local sensors monitoring different reference crops growing at difference reference fields, stored in a reference dataset. The instructions for administration of agricultural practices to growing crops is based on an analysis of the reference dataset, to identify the agricultural practices applied to a correlated reference field(s) that obtained optimal yields and/or quality of the reference crops, with the prediction that a similar optimal yield and/or quality may be achieved for the target crop. The reference dataset is in contrast, for example, in comparison to other methods that rely, for example, on pre-programmed settings of an agricultural controller, manual experience gained by the grower from a small number of fields, and/or published guidelines which represent general best practices but are not customized for the target field.

At least some of the systems and/or methods and/or code instructions described herein provide an improvement to the technology of administration of agricultural practices to growing crops by computing customized instructions for administration of agricultural practices to the target crop and/or target field, for example, in comparison to other methods that rely on common general (i.e., non-customized) guidelines generated for multiple varying fields.

At least some of the systems and/or methods and/or code instructions described herein provide an improvement to the technology of automated administration of agricultural practices to a target field by an agricultural controller, for example, an automated irrigation system, an automated fertilization system, and automated bio-stimulant application system. At least some of the systems and/or methods and/or code instructions described herein improve the ability of the agricultural controller to optimize yield and/or quality of the target crop at the target event (e.g., harvest) based on computation of the instruction for administration of agricultural practices (as described herein).

At least some of the systems and/or methods and/or code instructions stored in a data storage device executable by one or more hardware processors described herein provide a technical solution to the technical problem of determining instructions for administration of one or more agricultural practices to a target field in which target crops are grown. Common agricultural practice is for the grower, manager, and/or consultant to manually determine the time for administration of the agricultural practice(s) based on different indicators and/or milestones, based on gut instinct, experience, and/or training. Moreover, such manual timing does not consider the actual physiological condition of the plant. Critical cultural practices are commonly performed based on phenological stage and/or environmental conditions rather than actual plant physiological conditions. Moreover, interactions are not generally considered, for example, interaction between pest and plant diseases and the physiological condition of the crop. Such manual timing is generally inaccurate, leading to less than optimal growing results in terms of crop quality and/or quality. For example, the results of the administration of a certain chemical product based on manual practice and based on parameters such as weather conditions does not achieve the desired results and/or achieves less than optimal results. As a result, the larger the number of agricultural practices that are applied to the crop (which are applied without the operator being certain about the actual impact and/or efficiency), the higher the uncertainty about the final yield and/or quality of the crop (e.g., at harvest), as a consequence of the cumulative effect of each agricultural practice on the final result. The lack of consistency in the response of crops to different agricultural practices is well documented by studies in the literature. Such studies attribute the reduced efficiency of the administered agricultural practices to different crops according to the manual practices to external factors such as extreme climate conditions, and/or uncontrolled mistakes along the management.

In contrast to the common manual timing practice for administration of the agricultural practice(s), at least some implementations of the systems, methods, and/or code instructions described herein compute instructions for administration of the agricultural practice(s) to the target field based on output of crop physiological sensor(s) which provide an indication of the physiological condition of the target crop at the target field. The crop physiological sensor(s) collect data continuously and/or in short intervals along the growing season. The timing for administration of the agricultural practice(s) to the target field based on output of crop physiological sensor(s) predicts overall optimal crop results in terms of crop quantity and/or crop quality.

When high temporal resolution crop physiological sensors are implemented, in combination with frequent computations of the state parameter (e.g., every minute, 10 minutes, hour, or other interval), high resolution instructions for administration of the agricultural practice(s) to the target field may be obtained. For example, the time during the day to apply the agricultural practice(s). The time during the day may affect the stress condition of the crop, for example, early in the morning versus midday, which will affect its response to a certain application or practice.

At least some of the systems and/or methods and/or code instructions described herein provide a technical solution to the technical problem of determining instructions for administration of a newly developed agricultural practice to a target field in which target crops are grown. Operators cannot rely on training and/or experience, since the newly developed agricultural practice has not yet been fully applied by different operators sufficiency for administration using the common manual methods. One problem is the lack of affordable and/or accurate tools for identifying and quantifying different state (e.g., stress) levels on line, thwart their application at commercial level.

At least some of the systems and/or methods and/or code instructions described herein address the technical problem by providing instructions for administration of one or more agricultural practices with the prediction of optimized crop quality and/or quality (e.g., at the end of the growing season, at harvest time). In contrast, currently available tools for characterizing state (e.g., stress) of crops lack the ability for identifying the different stressors at given time intervals during the growing season, which makes such tools unsuitable for determining instructions for applying the agricultural practice to obtain optimal crop quality and/or quality. For example:

Nutritional deficit or toxicity is commonly performed as a visual symptom analysis and/or based on leaf sampling for lab analysis. Although these approaches are generally accurate at a quantitative level, these approaches are very limited in terms of capability of monitoring continuously the nutritional status of the crop during the season or even a specific stage of development, making such approaches unsuitable for determining the timing for administration of agricultural practices to the crops. This limitation has tried to be solved using remotely sensed platforms such as satellite or drone aerial multispectral images. However, the temporal resolution of such images is still too low for determining timing of agricultural practices. Moreover, due to high operational costs, the time intervals between images cannot be increased sufficiently.

Water deficit: A generally accurate approach for measuring plant water condition is through the measurement of plant water potential with pressure chamber. In practice, this approach is used only among high end fruit growers or researchers since it is a highly time-consuming task even for very skilled professionals, making it inviable for large scale operations and continuous monitoring, and therefore unsuitable for determining instructions for administration of agricultural practices. In addition, changes in stomatal conductance are also used for monitoring water deficits in many crops. Diffusion porometers provide a good indicator of water stress in many species but are extremely labor-intensive and not practical for commercial farm use. Finally, some growers still use infrared temperature measurements, but these measurements lack accuracy due to high environmental interference. None of these methods are suitable for determining the timing to apply agricultural practices to obtain optimal crop results.

Photosynthesis—the blockage from light, temperature, relative humidity or air pollution comprise various factors that affect a plant's photosynthesis rate may be identified and quantified through the use of specially designed monitoring instrumentation such as SAP flow meter or photosynthesis monitors. Despite the possibility of accurately measuring stress, their high price limits the application to large scale commercial farming. As such, these methods are unsuitable for determining the timing to apply agricultural practices to obtain optimal crop results.

At least some of the systems, methods, apparatus, and/or code instructions described herein do not simply perform automation of a manual procedure, but perform additional automated features which cannot be performed manually by a human using pencil and/or paper.

At least some of the systems and/or methods and/or code instructions described herein provide a new, useful, and non-conventional technique for using crop physiological sensor(s) to select and/or apply agricultural activities to the target field.

At least some of the systems and/or methods and/or code instructions described herein improve the functioning of a client terminal (e.g., mobile device) and/or computing device, by enabling a user to quickly and easily determine instructions for application of one or more agricultural practices to a target field growing target crops, optionally via an improved GUI that implements a particular process for computation of instructions for application of one or more agricultural practices to the target field.

At least some of the systems and/or methods and/or code instructions stored in a storage device executed by one or more processors described here improve an underlying process within the technical field of agriculture and/or growing of crop, in particular, within the field of application of agricultural practices for improving crop yields and/or quality.

At least some of the systems and/or methods and/or code instructions stored in a storage device executed by one or more processors described here do not simply describe the computation of instructions for administration of the agricultural practice(s) to the target field using a mathematical operation and receiving and storing data, but combine the acts of using outputs of crop physiological sensor(s) and using a classifier based on a dataset of physiological data collected from crop physiological sensor(s) of multiple reference fields. By this, at least some of the systems and/or methods and/or code instructions stored in a storage device executed by one or more processors described here go beyond the mere concept of simply retrieving and combining data using a computer.

At least some of the systems and/or methods and/or code instructions stored in a storage device executed by one or more processors described herein are tied to physical real-life components, including one of more of: crop physiological sensor(s), a hardware processor(s) that executes code instructions for computing the instructions for administration of the agricultural practice, a data storage device (e.g., server), a display that presents the computed instructions for administration of the agricultural practice, and a network that connects client terminals associated with reference fields to the client terminal associated with the target field.

Accordingly, at least some of the systems and/or methods and/or code instructions described herein are inextricably tied to computing technology and/or network technology to overcome an actual technical problem arising in management of administration of agricultural practices to crops growing at a field.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the terms state parameter and state index are interchangeable. The terms crop state parameter and state parameter are interchangeable.

Reference is now made to FIG. 1, which is a flowchart of a method of computing instructions for applying one or more agricultural practices to a target field based on output of one or more crop physiological sensor(s) and computed by one or more classifiers based on previously obtained instructions for administration of agricultural practices to respective reference fields, in accordance with some embodiments of the present invention. Reference is also made to FIG. 2, which is a block diagram of components of a system 200 for computing instructions for applying one or more agricultural practices to a target field by one or more classifiers and/or for training the one or more classifiers, in accordance with some embodiments of the present invention. System 200 may implement the acts of the methods described with reference to FIG. 1, optionally by a hardware processor(s) 202 of a computing device 204 executing code instructions 206A and/or training code 206B stored in a memory 206.

Computing device 204 receives for each of multiple reference fields, state parameter(s) based on reference crop physiological sensor(s) 208A located at the respective multiple reference fields via respective reference client terminals 210A, over a network 212. Computing device 204 may store the state parameter(s) in a reference dataset 214A (optionally hosted by a data storage device 214 associated with computing device 204). It is noted that reference dataset 214A may store the raw data outputted by reference crop physiological sensor(s) 208A, and/or may store values computed according to the raw data. The values may be computed according to the raw data outputted by reference crop physiological sensor(s) 208A by respective reference client terminals 210A and/or by computing device 204. A classifier 214B (optionally stored in data storage device 214) is trained according to the data stored in reference database 214A, as described herein. A target client terminal 210B accesses computing device 204 to obtain instructions for administration of one or more agricultural practices to a target field growing target crops, based on state parameter(s) of the target field indicative of a current state of the crop (e.g., physiological conditions parameters indicative of a physiological condition of the target crop at the target field, growth parameter(s) indicative of growth of the target crop, and/or stress parameter(s) indicative of stress experienced by the target crop) computed based on output of target crop physiological sensor(s) 208B installed at the target field.

Computing device 204 may be implemented as for example, a network server, a computing cloud, and a virtual server.

Each client target client terminal(s) 210B and/or reference client terminal 210A may be implemented as, for example, a virtual machine, a desktop computer, a thin client, a mobile device (e.g., a Smartphone, a Tablet computer, a laptop computer, a wearable computer, glasses computer, and a watch computer).

It is noted that target client terminal(s) 210B and reference client terminal(s) 210A may be implemented as the same client terminal(s), and/or as different client terminal(s). Similarly, reference crop physiological sensor(s) 208A and target crop physiological sensor(s) 210B may be implemented as the same sensor(s) and/or as different sensor(s). For example, the same mobile device may act as a certain reference client terminal when transmitting data from associated crop physiological sensor(s) that are acting as reference crop physiological sensor(s) to computing device 204. The same mobile device may act as a certain target client terminal when receiving instructions for administration of the agricultural practice from computing device 204 based on data outputted from associated crop physiological sensor(s) that are acting as target crop physiological sensor(s).

Each client target client terminal 210B and/or reference client terminal 210A may receive the data based on outputs of respective crop physiological sensor(s) 208B and 208A via one or more sensor data interfaces, for example, a network interface, a wire connection, a wireless connection, other physical interface implementations, and/or virtual interfaces (e.g., software interface, application programming interface (API), software development kit (SDK)).

Computing device 204 provides services (e.g., one or more of the acts described with reference to FIG. 1) to target client terminal(s) 210B over network 212, for example, by providing software as a service (SaaS) to the target client terminal(s) 210B, providing an application for local download to the target client terminal(s) 210B, and/or providing functions via a remote access session to the target client terminal(s) 210B, such as through a web browser and/or application stored on a Mobile device.

Hardware processor(s) 202 of computing device 204 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 202 may include one or more processors (homogenous or heterogeneous), which may be arranged for parallel processing, as clusters and/or as one or more multi core processing units. Memory (which may also be referred to herein as a program store) 206 stores code instructions implementable by processor(s) 202. Memory 206 may be implemented as, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 206 stores code 206A that executes one or more acts of the method described with reference to FIG. 1 and/or training code 206B that trains the classifier, as described herein.

Computing device 204 may include a data storage device 214 for storing data, for example, the trained classifier 214B and/or reference dataset 214A storing data based on output of reference crop physiological sensor(s) 208A. Data storage device 214 may be implemented as, for example, a memory, a local hard-drive, a removable storage unit, an optical disk, a storage device, and/or as a remote server and/or computing cloud (e.g., accessed via a network connection).

Each of computing device 204, target client terminal(s) 210B and/or reference client terminal(s) 210A may include a respective network interface for connecting to network 212, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 212 may be implemented as, for example, the internet, a local area network, a virtual network, a wireless network, a cellular network, a local bus, a point to point link (e.g., wired), and/or combinations of the aforementioned.

Target client terminal(s) 210B and/or reference client terminal(s) 210A may include and/or be in communication with a respective user interface 216A-B that includes a mechanism for a user to enter data (e.g., select the agricultural practice) and/or view presented data (e.g., the instructions for administration of the agricultural practice), for example, via a graphical user interface (GUI). Exemplary user interfaces 216A-B include, for example, one or more of, a touchscreen, a display, a keyboard, a mouse, and voice activated software using speakers and microphone. The GUI may be stored as respective code 218A-B within respective data storage devices and/or memory associated with respective target client terminal(s) 210B and reference client terminal(s) 210A.

Exemplary reference and/or target crop physiological sensors 208A-B include: dendrometer (i.e., trunk microvariation sensor), stem diameter sensor, fruit diameter sensor, leaf diameter sensor, crop growth rate sensor, canopy and/or leaf temperature sensor, soil moisture sensor, environmental temperature sensor, relatively humidity sensor, solar radiation sensor, wind velocity and direction sensor, and remotely sensed imaging (e.g., from satellite, airborne or drone).

At 102, a reference dataset is created, provided, and/or updated. One or more classifiers are trained according to the reference dataset. The term reference dataset and training dataset are interchangeable.

The reference dataset stores records for each of multiple reference fields. Each record stores:

An indication of one or more state parameters indicative of the current state of the crop, for example, stress experienced by a reference crop at the respective reference field. The crop state parameters may include, for example raw data outputted by the sensor(s), aggregation of data outputted by sensor(s) (e.g., computation of an average value of the data outputted by the sensor(s) over a time interval), and/or computation of one or more values according to the data outputted by the sensor(s) (e.g., computed according to a function, equation, and/or machine learning algorithm). The crop state parameter(s) may include, for example, one or more stress parameters indicative of stress experienced by the target crop, one or more growth parameters indicative of growth of the crop, and/or one or more physiological parameters indicative of a physiological condition of the crop.

The state parameters are computed based on output of reference crop physiological sensor(s) monitoring the respective reference crop. Multiple state parameter(s) computed over multiple sequential time intervals spanning one or more growing seasons (or portions thereof) may be stored in association with an indication of the respective time intervals, for example, a timestamp indicating the phenological stage of the reference crop, calendar date and/or degree date. Records storing the state parameter(s) may start at a certain phenological stage according to the type and/or variety of the reference crop. Deciduous orchards for example, may start the records of the growing days with reproductive or vegetative bud break depending on the species. In another example, perennials may be set to start according to the first leaves bloom. In yet another example, for annual crops (i.e., vegetables or grains), beginning of the growing days usually start on transplanting or emergence date, respectively.

An indication of instructions of agricultural practice(s) applied to the respective reference field. For example, the time interval when the agricultural practice(s) were applied to the respective reference field. It is noted that the record may store data from which the instructions are dynamically computed, rather than explicitly storing the instructions. For example, storing the agricultural practice(s) that was applied to the reference field, and storing a timestamp indicating when the agricultural practice(s) was applied. The indication of the agricultural practice(s) applied to the respective reference field may be manually entered by the operator of the respective reference field (e.g., via a GUI presented on a display of the respective reference client terminal) and/or automatically provided based on executing code (e.g., an automated irrigation system controller provides an indication of applied irrigation).

Is it noted that the indication of instructions of agricultural practice(s) applied to the respective reference field include when the agricultural practice(s) were applied, but not necessarily how the agricultural practices were applied (e.g., duration). The duration of administration of the agricultural practice may be determined according to dosage and/or intensity, based on common practice guidelines. For example, as defined by the manufacturer (e.g., in case of chemicals), according to the type of crop, based on criteria determined by the grower (e.g., based on cultural practices), and/or according to the soil type (e.g., in the case of irrigation).

Optionally, the instructions for administration of the agricultural practice(s) to the target field (as described herein) may be computed according to the stored instructions of agricultural practice(s) applied to the respective reference fields, which may represent a fine tuning of the common practices for improving yield and/or quality of the target crop, for example, adjustment within a range.

An indication of yield and/or quality of the reference crop at a historical reference event, for example, at the end of the growing season, and/or at a certain degree day or growth stage. Exemplary indications of yield and/or quality of the reference crop include among others that might be developed in the future: size, color, market grading, protein content, sugar concentration or combination of secondary metabolites.

A reference field profile including multiple parameters that remain substantially static over the growing season of the reference crop growing in the reference field. The reference field profile correlates to the target field profile discussed in additional detail below, for example, one or more parameters of the reference field profile are similar or match to one or more parameters of the target field profile.

The reference dataset, which may be hosted by a server, may be created and/or updated based on data transmitted by respective reference client terminals of corresponding respective reference fields over the network. Each reference client terminal aggregates output of reference crop physiological sensor(s) that monitor the respective reference crop. The reference client terminals may locally compute the state parameter(s), and transmit the state parameter(s) to the server, and/or the reference client terminals may transmit an indication of the output of the sensor(s), with the server computing the state parameter(s) according to the received indications.

State parameter(s) may be computed for respective reference fields based on output of reference crop physiological sensor(s), for example, every hour, every 6 hours, every 12 hours, every day, every 3 days, every week, or other time intervals.

One or more classifiers are trained according to the training dataset (i.e., the reference dataset) for classifying the selected agricultural practice(s) and state parameter(s) of a target field into instructions for applying the agricultural practice(s) to the target field. The classifier is trained to output instructions, where the yield and /or quality of the target crop at a future target event is increased when the instructions for administration of the agricultural practice(s) to the target field are implemented relative to the yield and/or quality of the target crop that would be obtained at the future target event corresponding to the historical reference event(s) when an alternative administration of the agricultural practice(s) is implemented, for example, when the agricultural practice(s) is applied at a different time than the instructions define and/or when the agricultural practice(s) is not applied.

Instructions for applying the agricultural practice(s) include a time interval for applying the selected agricultural practice, for example, in terms of calendar date, degree day, and/or phenological stage. Optionally, the instructions for applying the agricultural practice(s) may include one or more additional instructions, for example: dosage (e.g., for chemical products and/or bio-stimulants), concentration (e.g., for fertilizer), volume (e.g., for irrigation), intensity (e.g., for different cultural practices, such as pruning), and/or other quantitative definition for a certain agricultural practice. It is noted that the additional instructions may represent a fine tuning of common practices. When the additional instructions are not computed (e.g., not yet available such as during a first season when data is being collected), the additional instructions may be determined, for example, by the grower, based on common practices. For example, based on manufacturer instructions in the case of chemical products or bio-stimulants, fertilizers, and other materials or substances, and based on farming protocols and/or experience relating to other agricultural practices, and other technologies that may be available in respect of the quantities of water to apply in irrigation as independently by the grower depending on its own environmental conditions. The additional instructions may be computed, for example, after a growing season during which output of sensor(s) has been collected, for adjustment of dosage, quantity, intensity, and/or other quantitative factors.

It is noted that the classifier may be entirely automatically created and/or trained. Alternatively, at least some manual intervention is performed, for example, user may design hand crafted features, and/or add agricultural knowledge to a decision tree implementation of the classifier.

Optionally, multiple classifiers are trained, where each classifier is trained according to common reference field profiles. The common reference field profiles may be determined according to a correlation requirement that defines the maximum difference between the reference field profiles and/or defines the required similarity between the reference field profiles. Alternatively or additionally, a single classifier is trained based on the common reference field profiles.

The classifier(s) may be dynamically trained according to the most updated version of the reference dataset (i.e., storing the most updated data), optionally in response to receiving a request for classification. Alternatively or additionally, the classifier(s) may be pre-trained based on a certain version of the reference dataset. The classifier(s) may be updated (e.g., dynamically in response to new data, and/or at predefined intervals of time) according to the newly received data.

The classifier(s) may be implemented as one or multiple classifiers and/or artificial intelligence code. Examples of classifier implementations include: code instructions for searching records of the reference dataset (e.g., by matching the state parameter(s) of the target field to state parameter(s) of the records), a map that maps input to records of the reference dataset, decision trees, logistic regression, k-nearest neighbor, one or more neural networks of various architectures (e.g., artificial, deep, convolutional, fully connected), support vector machine (SVM), and/or combinations of the aforementioned.

Reference is now made to FIG. 3, which is a dataflow diagram depicting dataflow for creation of a reference dataset 314A, in accordance with some embodiments of the present invention. Crop physiological sensor(s) 308 (located in respective reference fields) output data 310 of reference crops located at the respective reference field, for storage in the reference dataset 314A. An indication of agricultural practices 312 applied to respective reference crops (e.g., cultivation, chemigation, fertigation, irrigation) is stored in reference dataset 314A. Reference dataset 314A may be updated in real-time, continuously, at predefined events, and/or when new data is provided. State parameter(s) 316 are computed according to the sensor data. Reference dataset 314A may store for each respective reference field, the state parameter(s) and/or raw sensor data in association with a time reference (e.g., growth stage of the reference crop, degree day, and/or calendar day), and applied agricultural practice(s).

Referring now back to FIG. 1, at 104, a target field profile of the target field may be provided. The target field profile may include multiple parameters. The target field profile may be stored in a dataset hosted by a data storage device, and/or manually entered by a user (e.g., via a GUI), and/or automatically extracted from datasets (e.g., hosted by servers). The target field profile may include parameters that remain substantially static over the growing season of the target crop growing in the target field. Exemplary parameters of the target field profile include:

Company: denoting the name of the company that owns the crop and/or manages irrigation of the crop.

Field name: denoting the name of the field where the crop is growing.

Plot ID: denoting the identification of the field where the crop is growing, for example, defined by a land registry.

Location & coordinates: denoting geographical location of the field where the crop is growing, for example, city, street, geographical coordinates (e.g., latitude, longitude).

Elevation: denoting the elevation above sea level of the field.

Slope and Slope exposure: denoting the inclination and direction of inclination of the field.

Field type: denoting whether the data is being provided based on sensor measurements associated with the field, or whether the crop is a target crop for which the dynamic crop coefficient is requested.

Greenhouse/open field/orchard/other: denoting whether the field is open, a green house, an orchard, or something else.

Crop species and/or variety: denoting the species and/or variety of the crop.

Planting date: denoting the date of planting of the crop, may be used to define the growing season.

Agricultural produce purpose: denoting the end product of the crop, for example wine, fresh fruit, and industrial processing.

Spatial density: denoting the distance between and/or along rows and/or plants, optionally measured in density per square meter.

Planting system: denoting the method for planting the crops, for example, trellis, tree training, and pruning.

Yield nominal load (i.e. High, medium, low): an estimate of the amount of stress experienced by the field.

Soil physical description: denoting physical parameters of the soil, for example, horizontal number and depth, texture and separate percentage, stone percentage, and compaction.

Soil chemical description: denoting chemical parameters of the soil, for example, pH, salinity (EC), and carbonates. Optionally a range of value is provided.

Irrigation method: denoting the method of irrigating the crop, for example, drip, sprinkler, pivot, furrow, and flood.

Irrigation flow rate: denoting the irrigation flow rate for pressurized system, for example, low/high/emitter.

Canopy condition: denoting parameters of the canopy, for example, biomass (e.g., leaf area index (LAI), vegetation fraction) optionally measured in grams per square meter, nutritional condition, and sanitary condition (e.g., pests, weeds).

The reference field profiles of the reference fields stored in the reference dataset correspond to the target field profile.

The reference field profile and target field profile may include data respectively indicative of the reference crop physiological sensors and the target crop physiological sensors. The correlation between the reference field profile and target field profile may include a requirement for similarity of sensors, to improve accuracy of the state parameters based on corresponding sensor outputs.

The classifier may perform the classification according to records of the reference dataset associated with reference field profiles that correlate to the target field profile according to a correlation requirement defining the amount of similarity and/or difference between the reference field profile(s) and the target field profile. Classification according to the correlation between the reference field profile(s) and the target field profile may provide more accurate instructions and/or instructions that are more relevant to the target crop.

Optionally, a subset of reference fields that correlate to the target field according to the correlation of the target field profile of the target field and the reference field profiles of the reference fields are identified from the reference dataset. The classifier(s) may be dynamically trained according to the subset of reference fields, for example, the classifier(s) may search the subset of reference fields. Alternatively or additionally, the classifier(s) computed according to different reference fields profiles have been trained in advance and are stored. The relevant classifier(s) may be selected according to the target field profile.

At 106, a selection of one or more agricultural practice(s) for administration to the target field is obtained. Exemplary agricultural practice(s) include: irrigation, chemical pesticide, chemical fertilizer, pruning, thinning, harvesting, and bio-stimulant.

The agricultural practice(s) may be selected from a set (e.g., list) of potential agricultural practices. The set of potential agricultural practices may represent agricultural practices that are relevant to the target field. The set of potential agricultural practices relevant to the target field may be obtained, for example, from a dataset storing agricultural practices according to target field profiles, and/or may be extracted from the reference dataset according to an analysis that identifies agricultural practices applied to reference fields associated with referenced field profiles that correlate to the target field profile.

The agricultural practice(s) may be selected by a user via a graphical user interface (GUI) presented on a display of the target client terminal. The user may select the agricultural practice from the potential agricultural practices presented by the GUI.

At 107, output of the crop physiological sensor(s) at the target field is obtained. The output of the crop physiological sensor(s) may be pre-processed, for example, converted from analogue output to digital format, aggregated (e.g., computing the average value over a time interval), and/or downsampled.

The output of the crop physiological sensor(s) may be obtained by the target client terminal for transmission to the computing device.

At 108, state parameter(s) indicative of the current state of the target crop at the target field are computed based on output of target crop physiological sensor(s) monitoring the target crop. The state parameter(s) may be computed by the target client terminal, and/or may be computed by the computing device (e.g., server) based on an indication of output of the target crop physiological sensor(s) transmitted from the target client terminal to the server. The state parameter(s) may include stress parameters, for example, nutritional deficit, toxicity level, water deficit, and photosynthesis blockage, trunk shrinkage, fruit shrinkage, growth rate, assimilates flow, plant water movement, biomass development, etc.

The state parameter(s) may be associated with a timestamp indicative of a time interval during which the output of target crop physiological sensor(s) used to compute the state parameter(s) is obtained. For example, calendar day and time, phenological stage of the target crop, and degree day within a growing season.

Optionally, multiple state parameters are computed, for example, based on different combinations of sensor outputs and/or based on different computational functions. The multiple state parameters may be stored as a state profile.

The state parameter(s) provide an indication of the current state of the target crop (e.g., physiological condition, growth state, stress state of the target crop), at the time corresponding to the timestamp, and/or actual response of the target crop to environmental conditions and/or response to the applied agricultural practice(s).

The classifier may perform the classification according to the timestamp. For example, instructions to apply the selected agricultural intervention(s) at a time interval earlier than the timestamp are excluded.

The state parameter(s) may be manually selected by the user (e.g., via the GUI), may be a predefined system parameter, and/or may be automatically selected from multiple state parameters according to the selected agricultural practice and/or according to the target field profile. The selection of the state parameter(s) may be according to the type and/or variety of the respective target crop, which may be stored as a parameter(s) of the respective target crop. For a manual selection by the user, the presented state parameters may be first automatically selected from a dataset of state parameters to include state parameters that are relevant to the selected agricultural practice and/or relevant to the target field profile.

Optionally, the state parameter(s) include a normalized value within a range of maximum possible state and minimal possible state.

Optionally, the state parameter(s) is computed by code that executes an algorithm (e.g., function(s)) that computes the value of the state parameter(s) from the output of the sensor(s). Alternatively or additionally, the state parameter(s) is computed by one or more state classifiers. The state classifier(s) may be trained according to a state training dataset that stores output of crop physiological sensors and data indicative of a certain value of state, for example, a neural network trained based on satellite images of the crops and labels of values of the state parameter that may be manually entered and/or automatically computed by code. It is noted that the state parameters may represent intuitive values, for example, based on a scale in which high values represent high state, and low values represent low state. Alternatively or additionally, the state parameters may not necessarily be intuitive values, for example, weights and/or coefficients outputted by a neural network.

Optionally, multiple state parameters are computed. Each state parameters is associated with a respective sequential timestamp over a time interval. The state parameters may be computed, for example, every minute based on sensor output collected over the last minute and/or based on sensor output collected at points in time spaced apart by one minute, every 10 minutes, every hour, or other intervals of time. The multiple state parameters denote dynamic changes for the target field over the time interval. The multiple state parameters may be inputted into the classifier, for example, as a vector.

One exemplary state parameter is now discussed as an example and is not meant to be necessarily limiting. The Crop Water Stress Index (CWSI) is based on canopy surface temperature. The calculation of CWSI relies on two baselines: the non-water-stressed baseline, which represents a fully watered crop, and the maximum stressed baseline, which corresponds to a non-transpiring crop (stomata fully closed) due to low water supply to the crop. In addition to leaf and air temperature, the computation may be based on the air vapor pressure deficit.

Reference is now made to FIG. 4, which includes graphs depicting the fluctuation of CWSI in winter wheat under three different irrigation regimes (i.e., the higher the treatment number, the higher the stress level) and under three different approaches for computing the index, useful for helping to understand some embodiments of the present invention. Details of the CWSI are discussed further with reference to Yuan G, Luo Y, Sun X and Tang D. 2004. Evaluation of a crop water stress index for detecting water stress in winter wheat in the North China Plain. Agricultural Water Management 64 (2004) 29-40. doi:10.1016/50378-3774(03)00193-8. As depicted by the graphs, the state index value increases as the amount of applied water decreases, staying in most cases between the expected 0-1 range but differences may be seen between the different approaches to compute the CWSI. It is noted that different state indices may be used for different reference corps locations and conditions. The most suitable state index for the specific conditions of each reference crop is selected, as described herein.

Referring now back to FIG. 1, at 110, the state parameter(s) of the target field and the selected agricultural practice(s) are inputted into the classifier. The target field profile may be inputted into the classifier in associated with the state parameter(s) and the agricultural practice(s), or may be provided in advance for selection of the certain classifier and/or for identifying the subset of records of reference target fields that correlate to the target field profile.

The state parameter may be inputted into the classifier, even when the state parameter of the target crop does not directly match state parameter(s) of the reference crop, and/or does not directly match state parameter(s) of the reference crop corresponding to highest yield and/or quality. As discussed herein, the instructions for administration of the agricultural practice may be applied according to the state parameter(s), and/or instructions for performing other agricultural practices to adjust the state parameter may be outputted.

The state parameter(s) and the agricultural practice(s) may be provided, for example, as a message transmitted over the network to the computing device acting as a server, may be entered by a user via a GUI that accesses the classifier on the computing device, and/or provided via an API running on the target client terminal that communicates with the computing device.

The classifier classifies the state parameter(s) and the agricultural practice(s) into instructions for administration of the agricultural practice(s) to the target field. The classification performed according to the prediction that yield and/or quality of the target crop at a future target event (e.g., harvest, end of growing season, a certain degree date, a certain calendar date) is increased when the instructions for administration of the agricultural practice to the target field are implemented, relative to predicted yield and/or quality of the target crop at the future target event when an alternative administration of the agricultural practice(s) is implemented (e.g., applied at a different time, not applied, applied at a different way).

The classifier may perform the classification, for example, by searching the records of the training dataset, optionally the records correlated to the target field profile, to identify records associated with state parameter(s) that match (within a correlation requirement defining a tolerance in the matched values) to the inputted state parameter(s) of the target field, and records associated with agricultural practice(s) that match (within the correlation requirement) to the inputted agricultural practice(s). The classifier may obtain the instruction for administration of the agricultural practice(s) according to the records associated with the highest yield and/or quality of the reference crop. The results of the classifier represent a prediction that implementing the selected agricultural practice(s) (that obtained the highest yield and/or quality of the reference crop at the reference field(s)) to the target field, according to the same instructions used at the reference field, provide similar results for the target crops in terms of yield and/or quality.

Alternatively or additionally, the classifier computes a probability that implementing the selected agricultural practice(s) to the target field according to the outputted instructions results in the predicted yield and/or quality.

The instructions for administration may include a certain time for administration of the agricultural practice(s) to the target crop, for example, a certain phenological stage of the target crop, degree days, and a calendar date.

The instructions for administration may include quantitative factors for how to apply the agricultural practice(s), for example, dosage, concentration, quantity, intensity, and volume.

When the quantitative factors are not included in the instructions, the quantitative factors may be determined based on common practice and/or guideline, for example, based on manufacturer guidelines, the crop type, soil type, and/or grower's personal criteria.

The instructions for administration may include instructions to apply another agricultural practice(s) in addition to the selected agricultural practice(s). The another agricultural practice(s) is selected for adjusting the current state of the target crop (e.g., as measured by the state parameter(s) to another state of the target crop that is more suitable for administration of the selected agricultural practice(s). The another agricultural practice(s) may be selected according to a prediction that the another agricultural practice(s), when administered in addition to the selected agricultural practice(s), will obtain a higher yield and/or quality at the target event (e.g., harvest, end of season) that administration of the selected agricultural practice(s) without the additional agricultural practice(s). The instructions to apply another agricultural practice(s) may be selected for adjustment of the state parameter(s) of the target field, optionally according to state parameter(s) of reference fields(s) associated with prediction of highest yield and/or quality of reference products. For example, to apply irrigation, fertilization, and/or a chemical, to adjust the physiological state of the target crop, such that output of the crop physiological sensors is adjusted to result in the adjusted state parameter(s). For example, for an orchard (i.e., target crop) to be treated with a certain hormone, when the target field is associated with a different value of the state parameter than the value of the state parameter of the reference field in which the same hormone has been applied, the response to the same agricultural practice treatment may not be as effective for the target crop as it was for the reference crop. Such discrepancy does not necessarily indicate that there is a requirement to normalize the state index values between the reference field and the target field. The grower and/or manager of the target field may be provided with instructions to adjust the value of the state parameter of the reference crop to match (within a tolerance range) value of the state parameter of the reference field before applying the agricultural practice. Failure to adjust the value of the state parameter of the reference crop may result in reduced effectiveness of the agricultural practice, which may result in diminished yield and/or quality in comparison to the predicted potential yield and/or quality when the state parameter value is according to the reference crop. The instructions may define when to adjust the state parameter(s) of the target crop. The grower may not be able to wait too long to improve the value of the state parameter(s) of the target crop. For example, the application of the hormone may not be delayed until after the maturity process has started, since at that point there will be no effect of the hormone. The instructions outputted by the classifier based on the dataset provide the user (e.g., grower) with a more accurate estimation of the effect in the final yield and/or quality when applying the agricultural practice at a different value of the state parameter (i.e., indicative of physiological condition) than recommended. For example, when a certain agricultural practice(s) is less predicted to be less effective due to a different value of the state parameter, the user (e.g., grower) may make decisions accordingly. For example, the user may decide when it is more convenient to change the destination to a less strict market regarding physical damages to the fruit.

Reference is now made to FIG. 5, which is a schematic depicting dataflow from a target field 502 to a crop dataset 504, and back to target field 502, in accordance with some embodiments of the present invention. Exemplary data 506 flowing from target field 502 to crop dataset 504 includes: selected agricultural practice(s) for administration, output of crop physiological sensor(s), weather data, historical yield and/or quality of the crops, and/or computed value of the state parameter(s). The classifier receives the provided data and outputs, based on crop dataset 504, instructions for administration of the agricultural practice(s) to target field 504, as described herein.

Referring now back to FIG. 1, at 112, the instructions for administration of the agricultural practice(s) to the target field are provided to the target client terminal, for example, transmitted from the computing device to the client terminal as a message, via an API, and/or via the GUI. The agricultural practice(s) are administered automatically and/or manually to the target field according to the instructions, by a human implementation and/or controller implementation.

The instructions for administration of the agricultural practice(s) may include machine readable instructions (e.g., code, script), which are designed to be executed by an agricultural controller (e.g., processor) for automatic implementation of the agricultural practice, for example, code instructions for automatic irrigation.

Alternatively or additionally, the instructions for administration of the agricultural practice(s) are presented on a display of the target client terminal, optionally within the GUI, as human readable instructions for manual implementation by a user. For example, a multimedia (e.g., text, video, audio, and/or animation) presentation instructing the user on how to implement the instructions for administration of the agricultural practice(s).

At 114, one or more of acts 107-112 may be iterated.

The administration of the agricultural practice(s) to the target field according to the instructions may be monitored by iterating one or more acts 107-112. New instructions may be generated, and/or previously computed instructions may be adjusted.

Multiple state parameters collected over different sequential time intervals (based on output of target crop physiological sensors) may be dynamically classified to determine whether the instructions for administration of the agricultural practice(s) to the target field are adapted. The different time intervals may include: prior to administration of the agricultural practice(s) to the target field according to the instructions, during administration of the agricultural practice(s) to the target field according to the instructions, and after administration of the agricultural practice(s) to the target field according to the instructions.

At 116, the reference dataset may be dynamically updated, optionally in real time, based on real time outputs of reference crop physiological sensors at respective reference fields. The updating of the reference dataset occurs independently of execution of acts 104-114.

The target field may become a reference field, for example, after an automated analysis, and/or manual validation by an administrator. When the target field becomes a reference field, outputs of the target crop physiological sensors at the target field are uploaded to the reference dataset.

Various implementations of at least some of the systems and/or methods and/or code instructions stored in a data storage device executed by one or more processors delineated hereinabove and as claimed in the claims section below find experimental support in the following examples.

### EXAMPLES

Reference is now made to the following examples, which together with the above descriptions illustrate some implementations of the systems and/or methods and/or code instructions stored in a data storage device executed by one or more processors described herein in a non-limiting fashion.

Inventors performed an experiment, in which a newly developed bio-stimulant (i.e., selected agricultural practice) was evaluated in corn at an experimental field. The experiment spanned two consecutive seasons in 2016-2017. The experiment's goal was to identify the best time and plant physiological condition to maximize the efficiency of the tested bio-stimulant.

It is noted that that prior to the experiment, the bio-stimulant developers didn't have the control on the final results due to the lack of information on the state level of the plant combined with exact growth stages. Therefore, a multifactorial experiment was designed where different levels of water stress were applied during the seasons, while the bio-stimulant was applied on the recommended phenological stage (pre-tasseling) by the manufacturer plus other later stages during the season.

The experimented field was irrigated by a drip irrigation system and monitored by two soil moisture sensors, one stem diameter sensor, and one fruit size sensor per administration, with three replications per treatment and one set of climate sensors (weather station) close to the field (i.e., crop physiological sensors). Data was controlled by an irrigation controller and transmitted via remote communication units. The harvest was performed with a mechanical harvester that measures the weight and the humidity of the corn of each plot separately. As post processing, the weight data was normalized to 20% humidity.

The significance of the (e.g., continuous) plant monitoring by the crop physiological sensors in the timing of the bio-stimulant application (i.e., instructions for application of the agricultural practice) was observed at two levels. First, for identifying stress in the crop. Second, for defining the optimum phenological stage for making the bio-stimulant application. In general, it was observed that the bio-stimulant had a positive effect, over control non-stressed or medium-stressed treatments in biomass and cob development when the plants were under moderate or non-stress.

Reference is now made to FIG. 6, which is a graph depicting seasonal stem diameter measurements 602A-C accurately identifying the corresponding different water-stresses 604A-C, which directly affected the response of the bio-stimulant, in accordance with some embodiments of the present invention. For the 2016 season, the effect of the bio-stimulant was 6.6% on dry biomass and 5.8% on cob weight in the non-stressed treatments, 2.0% and 12.4%, respectively in the medium stress treatments, in comparison to no effect at all in high stressed treatments. These results show that a state parameter (e.g., stress parameter) may be computed according to the output of the crop physiological sensor, for example, the value(s) of the stem diameter may be mapped to a certain state parameter value. Moreover, the value of the state parameter affects the yield and/or quality of the harvested crop when the bio-stimulant is applied to the field having the certain state parameter. Therefore, the instructions for administration of the bio-stimulant may include instructions to adjust the state parameter of the field to a different state parameter to obtain the best outcome. Alternatively or additionally, the instructions for administration of the bio-stimulant may be affected by the current state parameter value of the field, for example, no bio-stimulant should be applied to a high stressed field.

In addition, inventors discovered that the time for applying the bio-stimulant was critical, significantly affecting the level of response of the crop to the applied bio-stimulant. The characterization of both the stress level and of the ideal phenological stage for applying the bio-stimulant was accurately achieved based on the data outputted by the crop physiological sensors (i.e., growth sensors: stem and fruit). These results indicate that the instructions for administration of the bio-stimulant computed according to the output of the crop physiological sensors may include the time for application of the bio-stimulant. In particular, according to the results from both season, the optimal time for administration of the bio-stimulant is at the very end of the vegetative growth period and/or just before the beginning of the reproductive period.

The experiment provides evidence that the crop physiological sensors (i.e., growth sensors) output data that is sensitive enough to clearly describe the corn growth pattern (i.e., the crop state parameter(s)), and to identify the precise timing and/or state level of the plant for maximum additional yield by the bio-stimulant application, as described herein.

Reference is now made to FIG. 7, which is a graph depicting dates of application of the bio-stimulant according to growth curves 702A-B of the corn during the 2016 and 2017 seasons respectively, in accordance with some embodiments of the present invention. Growth curves 702A-B are stem diameters in millimeters. Application of the bio-stimulant during 05/07 and 07/07 provided the best results.

Curves 702A (i.e., the stem diameter) clearly characterize the phenological stages of the crop during both seasons, showing a rapid growth during the vegetative stage since emergence until the growth reaches a plateau (around July 12th for both seasons). Later the stem started to diminish in diameter but still was reacting to water stress through the changes in the daily shrinkage. Growth curves 702A-B correspond to state parameters 704A-B. For both seasons the results show that the applications performed in early July (at the end of the vegetative stage) were the ones that significantly results in a higher effect of the bio-stimulant over the control treatments.

It is noted that the optimal timing for administration of the bio-stimulant (i.e., instructions for administration) cannot be identified by other known methods such as counting degree days, or visual evaluation of the growth stage. The experiment provides evidence that the use of crop physiological sensors (e.g., growth sensors) for characterizing the development stages and the state (e.g., stress levels) of the crop may be used to determine instructions for administration of a selected agricultural practice to the target field for optimal results, as described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant crop physiological sensor and state parameter(s) will be developed and the scope of the terms crop physiological sensor and state parameter(s) are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A computer implemented method of providing a client terminal with instructions for administration of at least one agricultural practice to a target field, comprising of:
obtaining a selection of at least one agricultural practice for administration to the target field;
computing based on output of at least one crop physiological sensor monitoring a target crop of the target field, at least one state parameter indicative of a state of a target crop at the target field;
inputting into at least one classifier, the at least one state parameter of the target field and the at least one agricultural practice;
classifying by the at least one classifier, the at least one state parameter and the at least one agricultural practice into instructions for administration of the at least one agricultural practice to the target field, wherein at least one of yield and quality of the target crop at a future target event is predicted to be increased when the instructions for administration of the at least one agricultural practice to the target field are implemented relative to the at least one of yield and quality of the target crop that is predicted at the future target event when an alternative administration of the at least one agricultural practice is implemented, wherein the at least one classifier computes instructions for administration of the at least one agricultural practice based on previously obtained instructions for administration of agricultural practices to respective reference fields associated with respective at least one state parameter, and at least one of yield and quality of respective reference crops at respective reference fields at historical reference events corresponding to the future target event; and
providing the instructions for administration of the at least one agricultural practice to the target field to the client terminal.

2. The method of claim 1, wherein the at least one state parameter includes at least one of: at least one stress parameter indicative of stress experienced by the target crop, at least one growth parameters indicative of growth of the target crop, and at least one physiological parameters indicative of a physiological condition of the crop.

3. The method of claim 1, wherein the instructions for administration comprises a certain time for administration of the at least one agricultural practice to the target crop.

4. The method of claim 3, wherein the certain time is selected from the group consisting of: a certain phenological stage of the target crop, degree days, and a calendar date.

5. The method of claim 1, wherein the instructions for administration comprise machine readable instruction provided to an agricultural controller for automatic implementation of the at least one agricultural practice.

6. (canceled)

7. The method of claim 1, further comprising:
providing a target field profile of the target field including a plurality of parameters remaining substantially static over the growing season of the target crop growing in the target field, and wherein the classifier performs the classification according to reference field profiles of respective reference fields correlated to the target field profile according to a correlation requirement;
selecting a subset of reference fields that correlate to the target field according to the correlation of the target field profile of the target field and the reference field profiles of the reference fields; and
dynamically training the at least one classifier according to the subset of reference fields.

8. (canceled)

9. The method of claim 1, further comprising:
monitoring administration of the at least one agricultural practice according to the instructions by iterating the inputting into the at least one classifier, and the classifying, for a plurality of state parameters associated with different sequential time intervals obtained at least one of: during administration of the at least one agricultural practice according to the instructions classified by the at least one classifier and after administration of the at least one agricultural practice according to the instructions classified by the at least one classifier, wherein the classifying the plurality of state parameters dynamically adjusts the instructions for administration of the at least one agricultural practice.

10. The method of claim 1, wherein the at least one state parameter is further associated with a timestamp including one or more members selected from the group consisting of: calendar day and time, phenological stage of the target crop, and degree day within a growing season, wherein the classifier further performs the classification according to the timestamp.

11. (canceled)

12. The method of claim 1, wherein the at least one classifier searches records of a dataset by matching the at least one state parameter of the target field to at least one state parameter of at least one reference field, wherein the dataset stores records each including: indications of at least one state parameter of respective reference fields, indications of agricultural practices administered to respective reference fields, and at least one of yield and quality of respective reference crops of the respective reference fields at historical reference events, wherein the instructions for administration of the at least one agricultural practice to the target field are obtained according to the indication of agricultural practices administered to the reference field of at least one matched record.

13. (canceled)

14. The method of claim 1, wherein the at least one state parameter is selected from the group consisting of: nutritional deficit, toxicity level, water deficit, and photosynthesis blockage.

15. The method of claim 1, wherein the at least one state parameter is computed by at least one state classifier trained according to a training dataset of output of crop physiological sensors and associated data indicative of a certain value of the state.

16. The method of claim 1, wherein the at least one state parameter comprises a plurality of state parameters each associated with a respective sequential timestamp over a time interval, wherein the plurality of state parameters denote dynamic changes for the target field over the time interval.

17. The method of claim 1, wherein the instructions include instructions for administration of another at least one agricultural practice to the target field, wherein the instructions for administration of another at least one agricultural practice are selected for adjustment of the at least one state parameter(s) of the target field associated with a prediction of at least one of yield and quality of the target crop at the future target event according to the at least one adjusted state parameter(s) relative to the at least one of yield and quality of the target crop at the future target event according to the at least one state parameter(s) without the adjustment.

18. The method of claim 1, wherein the at least one crop physiological sensor is selected from the group consisting of: dendrometer, stem diameter sensor, fruit diameter sensor, leaf diameter sensor, crop growth rate sensor, leaf temperature sensor, soil moisture sensor, environmental temperature sensor, solar radiation sensor, wind sensor, relatively humidity sensor, and airborne or satellite image sensor.

19.-21. (canceled)

22. The method of claim 1, wherein the at least one agricultural practice is selected from the group consisting of: irrigation, chemical pesticide, chemical fertilizer, pruning, thinning, harvesting, and bio-stimulant.

23. A computer implemented method of training at least one classifier for classifying at least one agricultural practice and at least one state parameter of a target field into instructions for administration the at least one agricultural practice to the target field, comprising:
providing a training dataset, including a plurality of records for a plurality of reference fields, each record of each respective reference field storing: instructions of at least one agricultural practice administered to the respective reference field, at least one stress parameter indicative of a state of a reference crop at the respective reference field computed based on output of at least one crop physiological sensor monitoring the reference crop, and at least one of yield and quality of the target crop at a historical reference event; and
training at least one classifier according to the training dataset for classifying at least one agricultural practice and at least one state parameter of a target field into instructions for administering the at least one agricultural practice to the target field, wherein at least one of yield and quality of the target crop at a future target event is predicted to be increased when the instructions for administration of the at least one agricultural practice to the target field are implemented relative to the at least one of yield and quality of the target crop that is predicted at the future target event when an alternative administration of the at least one agricultural practice is implemented.

24. The method of claim 23, wherein each record of each respective reference fields stores a plurality of at least one state parameter computed at each of a plurality of sequential time intervals spanning an entire growing season of the respective reference crop growing at the respective reference field.

25. The method of claim 24, wherein the training dataset is updated based on an indication of the at least one state parameter for each of the plurality of sequential time intervals transmitted by each of a plurality of reference client terminals associated with each respective reference field to a server storing the training dataset
wherein the classifier is trained in real time according to the updated version of the training dataset.

26. (canceled)

27. The method of claim 23, wherein each record of each respective field stores a reference field profile including a plurality of parameters remaining substantially static over the growing season of the reference crop growing in the reference field, and wherein the at least one classifier is trained according to the reference field profiles.

28. A system for providing a client terminal with instructions for administration of at least one agricultural practice to a target field, comprising:
a non-transitory memory having stored thereon a code for execution by at least one hardware processor, the code comprising:
code for obtaining a selection of at least one agricultural practice for administration to the target field;
code for computing based on output of at least one crop physiological sensor monitoring a target crop of the target field, at least one state parameter indicative of a state of a target crop at the target field;
code for inputting into at least one classifier, the at least one state parameter of the target field and the at least one agricultural practice;
code for classifying by the at least one classifier, the at least one state parameter and the at least one agricultural practice into instructions for administration of the at least one agricultural practice to the target field, wherein at least one of yield and quality of the target crop at a future target event is predicted to be increased when the instructions for administration of the at least one agricultural practice to the target field are implemented relative to the at least one of yield and quality of the target crop that is predicted at the future target event when an alternative administration of the at least one agricultural practice is implemented, wherein the at least one classifier computes instructions for administration of the at least one agricultural practice based on previously obtained instructions for administration of agricultural practices to respective reference fields associated with respective at least one state parameter, and at least one of yield and quality of respective reference crops at respective reference fields at historical reference events corresponding to the future target event; and
code for providing the instructions for administration of the at least one agricultural practice to the target field to the client terminal.
